(19) United States
(12) Patent Application Publication
(10) Pub. No.: US 2026/0135668 A1
(43) Pub. Date: May 14, 2026

(54) Communication Method and Related Apparatus

(71) Applicant: Huawei Technologies Co., Ltd., Shenzhen (CN)

(72) Inventors: Wenjun Li, Shenzhen (CN); Wei Ruan, Shanghai (CN); Yunsi Ma, Shanghai (CN)

(73) Assignee: Huawei Technologies Co., Ltd., Shenzhen (CN)

(21) Appl. No.: 19/442,426

(22) Filed: Jan. 7, 2026

Related U.S. Application Data
(63) Continuation of application No. PCT/CN2024/098958, filed on Jun. 13, 2024.

(30) Foreign Application Priority Data
Jul. 11, 2023 (CN) 202310852463.X

(51) Int. Cl. H04L 5/00; H04B 17/309; H04L 43/0823

(52) U.S. Cl. CPC H04L 5/0053; H04B 17/346; H04L 43/0823

(57) ABSTRACT

A communication method includes receiving a Wi-Fi data frame from a transmitter; obtaining interference information of the Wi-Fi data frame, where the interference information comprises a proportion of interfered orthogonal frequency-division multiplexing (OFDM) symbols or a first quantity of interfered medium access control (MAC) protocol data units (MPDUs); and sending the block acknowledgment frame to the transmitter, where the block acknowledgment frame includes interference information.

### CROSS-REFERENCE TO RELATED APPLICATIONS

This is a continuation of International Patent Application No. PCT/CN2024/098958 filed on Jun. 13, 2024, which claims priority to Chinese Patent Application No. 202310852463.X filed on Jul. 11, 2023, all of which are hereby incorporated by reference.

### TECHNICAL FIELD

This application relates to the field of communication technologies, and in particular, to a communication method and a related apparatus.

### BACKGROUND

When a Wi-Fi device is used for communication, a transmitter usually selects a transmit parameter based on a packet error rate (or packet error ratio (PER)), for example, selects a modulation and coding scheme (MCS). The PER mainly depends on a signal-to-interference-and-noise ratio (SINR) of a signal received by a receiver. For example, with a same transmit parameter, a larger SINR indicates a lower PER. The SINR is affected by interference signal strength and noise intensity.

Decoding errors caused by impact of the interference signal strength and impact of the noise intensity usually occur simultaneously, making it impossible for the transmitter to sense interference impact on the receiver. This results in conservative selection of a transmit parameter, such as a low MCS, leading to a low air interface transmission rate.

### SUMMARY

Embodiments of this application disclose a communication method and a related apparatus. A receiver feeds back interference information to a transmitter, so that the transmitter takes impact of an interference signal into consideration, thereby improving accuracy of collecting statistics on a packet error rate by the transmitter.

According to a first aspect, an embodiment of this application discloses a first communication method. The method is applied to a receiver. The receiver in this embodiment of this application may be an access point (AP), or may be a station (STA). When the receiver is an AP, a transmitter may be an STA or an AP. When the receiver is an STA, a transmitter may be an AP or an STA. A function performed by the AP in this application may be performed by an apparatus (for example, a chip, a chip system, a circuit, or a means) in the AP, and a function performed by the STA in this application may be performed by an apparatus (for example, a chip, a chip system, a circuit, or a means) in the STA.

The method includes receiving a Wi-Fi data frame from a transmitter, and sending a block acknowledgment (BA) frame to the transmitter. The BA frame includes interference information of the Wi-Fi data frame. In other words, when the receiver is interfered and transmission of some subframes fails due to a collision, the interference information is fed back to the transmitter. In this way, the transmitter may take impact of an interference signal into consideration, thereby improving accuracy of collecting statistics on a packet error rate by the transmitter.

In some feasible examples, the Wi-Fi data frame includes a physical protocol data unit (PPDU), data to be transmitted in the PPDU is encoded into N orthogonal frequency-division multiplexing (OFDM) symbols, the interference information of the Wi-Fi data frame is a proportion of interfered OFDM symbols in the PPDU, and N is a positive integer.

The method further includes recording an error vector magnitude (EVM) of each of the N OFDM symbols through a physical layer (PHY), to obtain N EVMs, where the N EVMs include a first EVM, and an absolute value of the first EVM is a maximum value of absolute values of the N EVMs, determining a difference between the absolute value of the first EVM and the absolute value of each of the N EVMs through the PHY, determining a first quantity of differences greater than a first threshold through the PHY, and using a ratio of the first quantity to N as the proportion of the interfered OFDM symbols in the PPDU through the PHY.

In some feasible examples, the Wi-Fi data frame includes an aggregated medium access control (MAC) protocol data unit (AMPDU), the AMPDU includes M MAC protocol data units (MPDUs), the interference information of the Wi-Fi data frame is a quantity of interfered MPDUs in the AMPDU, and M is a positive integer.

The method further includes checking each of the M MPDUs through a MAC layer to obtain a first MPDU with a check error, determining, through the MAC layer, a second quantity of first MPDUs corresponding to an interfered OFDM symbol, where a difference between an absolute value of an EVM of the interfered OFDM symbol and an absolute value of a first EVM is less than a first threshold, the first EVM is a maximum value of absolute values of N EVMs, and the N EVMs include an EVM of each of N OFDM symbols obtained from PPDU encoding, and using the second quantity as the quantity of interfered MPDUs in the AMPDU through the MAC layer.

In some feasible examples, M is less than or equal to 256.

In some feasible examples, the interference information of the Wi-Fi data frame is located in a reserved field or a user-defined field of the block acknowledgment frame.

According to a second aspect, an embodiment of this application discloses a second communication method. The method is applied to a transmitter. The communication method includes sending a Wi-Fi data frame to a receiver, receiving a block acknowledgment frame from the receiver, where the block acknowledgment frame includes interference information of the Wi-Fi data frame, and determining a packet error rate of the Wi-Fi data frame based on a quantity of AMPDUs, a quantity of erroneous MPDUs, and the interference information of the Wi-Fi data frame. In this way, the receiver feeds back, to the transmitter, the interference information of the received Wi-Fi data frame, so that the transmitter takes impact of an interference signal into consideration, thereby improving accuracy of collecting statistics on the packet error rate by the transmitter.

In some feasible examples, the Wi-Fi data frame includes a PPDU, data to be transmitted in the PPDU is encoded into N OFDM symbols, the interference information of the Wi-Fi data frame is a proportion of interfered OFDM symbols in the PPDU, N is a positive integer, and the packet error rate PER of the Wi-Fi data frame is obtained through calculation according to the following formula:

$$P E R = max \{ \frac{error\_mpdu \_num}{aggr\_mpdu \_num} \times 100 \% - ppdu\_interf \_ratio , 0 \}$$

where error_mpdu_num is the quantity of erroneous MPDUs, aggr_mpdu_num is the quantity of AMPDUs, and ppdu_interf_ratio is the proportion of the interfered OFDM symbols in the PPDU.

In some feasible examples, the Wi-Fi data frame includes an AMPDU, the AMPDU includes M MPDUs, the interference information of the Wi-Fi data frame is a quantity of interfered MPDUs in the AMPDU, M is a positive integer, and the packet error rate PER of the Wi-Fi data frame is obtained through calculation according to the following formula:

$$P E R = \frac{error\_mpdu \_num - interf\_mpdu \_num}{aggr\_mpdu \_num} \times 100 \%$$

where error_mpdu_num is the quantity of erroneous MPDUs, aggr_mpdu_num is the quantity of AMPDUs, and interf_mpdu_num is the quantity of interfered MPDUs in the AMPDU.

According to a third aspect, an embodiment of this application discloses a communication apparatus. The apparatus is used in a receiver. In this embodiment of this application, a function performed by the receiver may be performed by an apparatus in the receiver. The apparatus has a function corresponding to the method according to any one of the first aspect or any feasible example in the first aspect. The function may be implemented by hardware, or may be implemented by hardware executing corresponding software. The hardware or the software includes one or more units corresponding to the foregoing function.

According to a fourth aspect, an embodiment of this application discloses a communication apparatus. The apparatus is used in a transmitter. In this embodiment of this application, a function performed by the transmitter may be performed by an apparatus in the transmitter. The apparatus has a function corresponding to the method according to any one of the second aspect or any feasible example in the second aspect. The function may be implemented by hardware, or may be implemented by hardware executing corresponding software. The hardware or the software includes one or more units corresponding to the foregoing function.

According to a fifth aspect, an embodiment of this application discloses a communication apparatus. The apparatus may be a transmitter or a receiver. The apparatus may include a processor. The processor is configured to enable, by executing instructions in a memory or through a logic circuit, the communication apparatus to perform the method in any one of the first aspect and the second aspect or the feasible examples.

In some feasible examples, the communication apparatus further includes one or more of a memory and a transceiver. The transceiver is configured to send and receive data and/or signaling.

According to a sixth aspect, an embodiment of this application provides a non-transitory computer-readable storage medium. The non-transitory computer-readable storage medium stores instructions. When the instructions are run by a processor, the method in any one of the first aspect and the second aspect or the feasible examples is performed.

According to a seventh aspect, an embodiment of this application provides a computer program product. The computer program product includes instructions. When the instructions are run by a processor, the method in any one of the first aspect and the second aspect or the feasible examples is performed.

According to an eighth aspect, this application provides a chip, including a processor configured to invoke, from a memory, instructions stored in the memory, and run the instructions, so that a communication apparatus in which the chip is installed performs the method in any one of the first aspect and the second aspect or the feasible examples.

According to a ninth aspect, this application provides another chip, including an input interface, an output interface, and a processing circuit. The input interface, the output interface, and the circuit are connected through an internal connection path. The processing circuit is configured to perform the method in any one of the first aspect and the second aspect or the feasible examples. Optionally, the chip further includes a memory. The input interface, the output interface, a processor, and the memory are connected through an internal connection path. The processor is configured to execute code in the memory. When the code is executed, the processor is configured to perform the method in any one of the first aspect and the second aspect or the feasible examples.

According to a tenth aspect, this application provides a chip system, including at least one processor and a communication interface. The communication interface and the at least one processor are interconnected through a line. The at least one processor is configured to run a computer program or instructions, to perform the method in any one of the first aspect and the second aspect or the feasible examples.

It should be understood that mutual reference may be made to the implementations and beneficial effects of the foregoing aspects.

### BRIEF DESCRIPTION OF DRAWINGS

The following describes accompanying drawings used in embodiments of this application.

FIG. 1 is a diagram of an architecture of a communication system according to an embodiment of this application;

FIG. 2 is a diagram of structures of an AP and an STA;

FIG. 3 is a diagram of a structure of an AMPDU;

FIG. 4 is a diagram of interaction in a communication method according to an embodiment of this application;

FIG. 5 is a diagram of determining a proportion of interfered OFDM symbols in a PPDU according to an embodiment of this application;

FIG. 6 is a diagram of determining a quantity of interfered MPDUs in an AMPDU according to an embodiment of this application;

FIG. 7 is a diagram of a structure of a BA frame;

FIG. 8 is a diagram of a structure of a communication apparatus according to an embodiment of this application;

FIG. 9 is a diagram of a structure of another communication apparatus according to an embodiment of this application; and

FIG. 10 is a diagram of a structure of an STA according to an embodiment of this application.

### DESCRIPTION OF EMBODIMENTS

Embodiments of this application may be applicable to a sensing system, applicable to a system that complies with the Institute of Electrical and Electronics Engineers (IEEE) 802.11 system standard, for example, 802.11bf, 802.11a/b/g, 802.11n, 802.11ac, 802.11ax, or a next generation thereof, for example, 802.11be, Wi-Fi 7, or EHT, or a further next generation standard, for example, a wireless local area network system that complies with an 802.11 series protocol, for example, Wi-Fi 8, UHR, or Wi-Fi AI, or a wireless personal area network system based on ultra-wideband (UWB), or applicable to a wireless local area network (WLAN) scenario. Alternatively, embodiments of this application may be applicable to a WLAN system, for example, an Internet of Things (IoT) network or a vehicle-to-everything (V2X) network. Certainly, embodiments of this application may be further applicable to another possible communication system, for example, a Long-Term Evolution (LTE) system, an LTE frequency-division duplex (FDD) system, LTE time-division duplex (TDD), a universal mobile telecommunications system (UMTS), a worldwide interoperability for microwave access (WIMAX) communication system, a communication system evolved after a fifth generation (5G) communication system (for example, a sixth generation (6G) communication system), or a non-3rd Generation Partnership Project (3GPP) communication system. This is not limited herein.

The following describes embodiments of this application with reference to the accompanying drawings in embodiments of this application.

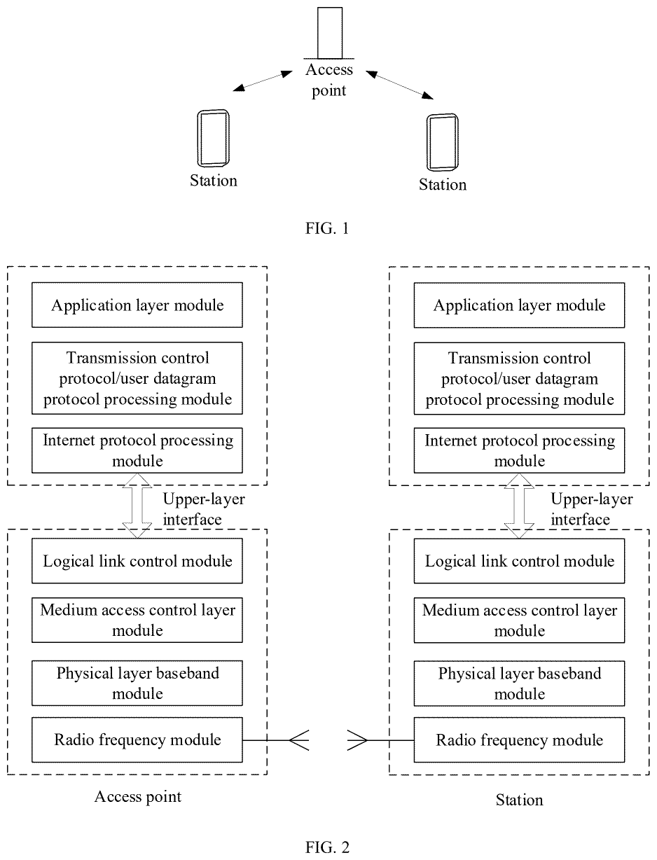

FIG. 1 is a diagram of a structure of a communication system according to an embodiment of this application. The communication system in FIG. 1 takes a WLAN as an embodiment. As shown in FIG. 1, an example in which the communication system includes one AP and two STAs is used for description. An STA associated with the AP can receive a radio frame sent by the AP, and can also send a radio frame to the AP. In addition, embodiments of this application are also applicable to communication between APs, or are applicable to communication between STAs. It should be understood that quantities of APs and STAs in FIG. 1 are merely examples, and embodiments of this application are not limited thereto. For example, more or fewer STAs that communicate with the AP may be further included. For another example, more or fewer APs that communicate with the STA may be further included. For conciseness of description, this is not described one by one in the accompanying drawings.

The STA in embodiments of this application is an apparatus having a wireless communication function, supports communication based on a WLAN protocol, and has a capability of communicating with another station or access point in the WLAN network. In a WLAN system, the station may be referred to as a non-AP STA. For example, the STA is any user communication device that allows a user to communicate with the AP and further communicate with the WLAN. The STA may be an entire device, or may be a chip or a processing system installed in the entire device. The device in which the chip or the processing system is installed may implement the method and the function in embodiments of this application under control of the chip or the processing system. For example, the STA may be various devices having a wireless communication function, for example, a handheld device, a vehicle-mounted device, a wearable device, a computing device, another processing device connected to a wireless modem, a user equipment (UE) in various forms, a mobile station (MS), a terminal, a terminal device (or terminal equipment), a portable communication device, a handheld device, a portable computing device, an entertainment device, a game device or system, a global positioning system device, or any other appropriate device configured to perform network communication via a wireless medium. For example, the STA may be a router, a switch, a bridge, or the like. Herein, for ease of description, the devices mentioned above are collectively referred to as stations or STAs.

The AP in embodiments of this application is an apparatus having a wireless communication function, supports communication based on a WLAN protocol, has a function of communicating with another device (for example, a station or another access point) in a WLAN network, and certainly, may further have a function of communicating with another device. In the WLAN system, the access point may be referred to as an AP STA. The AP may be an entire device, or may be a chip or a processing system installed in the entire device. The device in which the chip or the processing system is installed may implement the method and the function in embodiments of this application under control of the chip or the processing system. The AP in embodiments of this application may be an apparatus that provides a service for an STA. For example, the AP may be a communication entity like a communication server, a router, a switch, or a bridge. The AP may include base stations in various forms like a macro base station, a micro base station, and a relay station. Certainly, the AP may alternatively be a chip and a processing system in these devices in various forms, to implement the method and the function in embodiments of this application.

The WLAN system can provide high-speed and low-delay transmission, and may be applied to, for example, the internet of things industry, the vehicle-to-everything industry, the banking industry, enterprise offices, exhibition halls of stadiums, concert halls, hotel rooms, dormitories, wards, classrooms, supermarkets, squares, streets, production workshops, and warehousing. Certainly, a device supporting WLAN communication (for example, an access point or a station) may be a sensor node (for example, a smart water meter, a smart electric meter, or a smart air detection node) in a smart city, a smart device (for example, a smart camera, a projector, a display, a television, a sound system, a refrigerator, or a washing machine) in smart home, a node in the internet of things, an entertainment terminal (for example, a wearable device such as an augmented reality (AR) device or a virtual reality (VR) device), a smart device (for example, a printer, a projector, a loudspeaker, or a sound system) in smart office, a vehicle-to-everything device in vehicle-to-everything, infrastructure (for example, a vending machine, a self-service navigation station in a supermarket, a self-service checkout device, or a self-service ordering machine) in a daily life scenario, a device in a large-scale stadium and a music hall, or the like. Specific forms of the STA and the AP are not further limited in embodiments of this application, and are merely examples for description herein.

FIG. 2 is a diagram of structures of an AP and an STA. As shown in FIG. 2, the AP and the STA may include an antenna, a radio frequency (radio) module, a PHY baseband module, a MAC layer module, a logical link control (LLC) module, an Internet Protocol (IP) processing module, a Transmission Control Protocol (TCP)/User Datagram Protocol (UDP) processing module, and an application layer module. The IP module and the LLC module may communicate with each other through an upper-layer interface. There may be one or more antennas in the radio frequency module, and a quantity of antennas of the STA may be the same as or different from a quantity of antennas of the AP.

When a transmitter sends data to a receiver, the data starts from an application layer of the transmitter, passes through a TCP layer, an IP layer, an LLC layer, a MAC layer, and a PHY of the transmitter, then travels through a transmission link to a PHY of the receiver, passes through a MAC layer, an LLC layer, an IP layer, and a TCP layer of the receiver, and finally reaches an application layer of the receiver, and vice versa.

It should be noted that the AP and the STA may support the 802.11 standards. The 802.11 standards are mainly for a PHY and a MAC layer. Wi-Fi data frames on which this application primarily focuses are a PPDU and an AMPDU.

In the WLAN, data, control signaling, management signaling, or the like is transmitted between the AP and the STA by using an MPDU. An MPDU usually includes a frame header, a frame body, and a frame check sequence (FCS). The frame body is used to carry data, management information, or control information transmitted from an upper layer. For some specific types of MPDUs, for example, an acknowledgment frame, the frame body may not exist. The FCS is used to check whether the MPDU is correctly transmitted. Optionally, the frame header (or a MAC header) may include at least one of a frame control field, a duration or identifier (ID) field, an address information field, a sequence control field, a quality of service (QoS) control field, or a high throughput (HT) control field. In an example, for explanation of each field, refer to the IEEE 802.11 protocol. It should be understood that another field may be added to the MAC header or new meanings may be assigned to some fields in the existing MAC header.

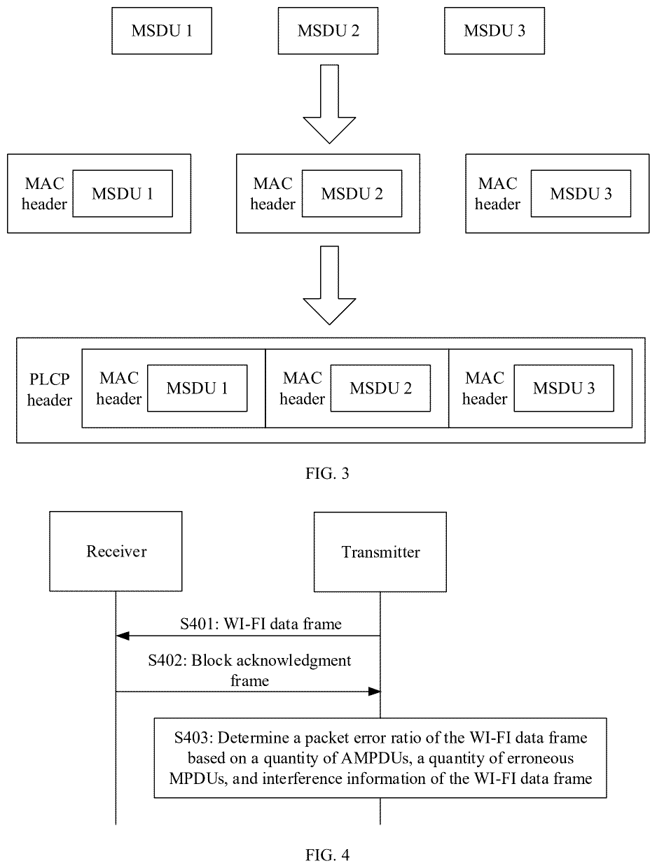

To improve performance of the WLAN, a frame aggregation technology is used at the MAC layer to aggregate a plurality of MPDUs into one AMPDU. For example, FIG. 3 is a diagram of a structure of an AMPDU. As shown in FIG. 3, a plurality of MAC service data units (MSDUs) are aggregated to form an aggregated MAC service data unit (AMSDU). The AMSDU and a MAC header form an MPDU, which is then sent to a PHY. The AMPDU aggregates a plurality of MPDUs, and several MPDUs are sent by using a unified Physical Layer Convergence Protocol (PLCP) preamble. This reduces PLCP preambles and PLCP headers, and effectively reduces overheads caused by channel contention and a physical layer preamble, improves transmission efficiency, and improves a system throughput.

A name of the MPDU entering a PLCP layer is changed to a physical service data unit (PSDU). The PSDU is added with a PLCP preamble and a PLCP header to form a PPDU. In a transmission process, the transmitter sends a PLCP preamble to the receiver to notify the peer end. The PLCP header may include physical parameters related to data transmission, such as signal, service, length of data to be transmitted, and check code. The check code may be an FCS, a cyclic redundancy check (CRC), or the like. This is not limited herein. In the PPDU, data to be transmitted is encoded into N OFDM symbols. A value of N is not limited in this application, and N may be a positive integer.

When a Wi-Fi device performs communication, the transmitter usually selects a transmit parameter, for example, selects an MCS based on a PER. The PER mainly depends on a SINR of a signal received by the receiver. For example, with a same transmit parameter, a larger SINR indicates a lower PER. The SINR is affected by interference signal strength and noise intensity. Generally, for all MPDUs in a same AMPDU, received signal strength is the same, and is mainly affected by wireless channel fading. However, because interference signals are random, strength of interference signals received by each MPDU in the AMPDU may be different, and an MPDU decoding error caused by interference is also referred to as an MPDU “collision”.

Decoding errors caused by impact of the interference signal strength and impact of the noise intensity usually occur simultaneously, making it impossible for the transmitter to sense interference impact on the receiver. This results in conservative selection of a transmit parameter, such as a low MCS, leading to a low air interface transmission rate.

Based on this, this application proposes a communication method. When a receiver is interfered and transmission of some subframes fails due to a collision, interference information is fed back to a transmitter, so that the transmitter takes impact of an interference signal into consideration, thereby improving accuracy of collecting statistics on a packet error rate by the transmitter.

The following describes the communication method according to an embodiment of this application. FIG. 4 is a diagram of interaction in a communication method according to an embodiment of this application. A communication apparatus in the communication method may include a transmitter and a receiver. The transmitter may be an AP, and the receiver may be an STA, or the transmitter may be an STA, and the receiver may be an AP, or the transmitter and the receiver are different APs or STAs. For a system architecture corresponding to the AP and the STA, refer to descriptions in FIG. 1. Details are not described herein again. A function performed by the AP in this application may be performed by an apparatus in the AP, and a function performed by the STA in this application may be performed by an apparatus in the STA. As shown in FIG. 4, the communication method includes the following steps.
S401: A transmitter sends a Wi-Fi data frame to a receiver.

Correspondingly, the receiver receives the Wi-Fi data frame from the transmitter.

The Wi-Fi data frame includes data to be transmitted. Wi-Fi frames may further include a Wi-Fi control frame and a Wi-Fi management frame. The Wi-Fi control frame is usually used in conjunction with a Wi-Fi data frame, and is responsible for area clearing, channel acquisition, carrier sensing, acknowledgment, and the like. The Wi-Fi management frame is mainly used to access and exit a wireless network and process association transfer between access points.

In this embodiment of this application, the Wi-Fi data frame may include a PPDU corresponding to a PHY or an AMPDU corresponding to a MAC layer.
S402: The receiver sends a block acknowledgment frame to the transmitter.

Correspondingly, the transmitter receives the block acknowledgment frame from the receiver.

The block acknowledgment frame includes interference information of the Wi-Fi data frame. The block acknowledgment frame, for example, a block acknowledgment frame, is referred to as a BA frame. A plurality of MPDUs are responded to by using one acknowledgment (ACK) frame, so that a quantity of ACK frames can be reduced.

Optionally, when the Wi-Fi data frame is a PPDU, the interference information of the Wi-Fi data frame is a proportion of interfered OFDM symbols in the PPDU. When the Wi-Fi data frame is an AMPDU, the interference information of the Wi-Fi data frame is a quantity of interfered MPDUs in the AMPDU. A method for determining the interference information is not limited in this application. The following separately describes the two types of Wi-Fi data frames.

1. When the Wi-Fi data frame is a PPDU, and data to be transmitted in the PPDU is encoded into N OFDM symbols, an EVM of each of the N OFDM symbols is recorded through a PHY of the receiver, to obtain N EVMs, a difference between an absolute value of a first EVM and an absolute value of each of the N EVMs is determined through the PHY of the receiver, a first quantity of differences greater than a first threshold is determined through the PHY of the receiver, and a ratio of the first quantity to N is used as the proportion of the interfered OFDM symbols in the PPDU through the PHY of the receiver.

N is a positive integer. The first EVM is a maximum value of the absolute values of the N EVMs. Because the EVM is a negative number, a larger absolute value of the EVM indicates better performance. The first EVM may be understood as an optimal EVM, and may be denoted as best_evm. A quantity of first EVMs is not limited in this application. Optionally, if N is equal to 1, the quantity of first EVMs is 1. If N is greater than 1, the quantity of first EVMs may be greater than or equal to 1 and less than or equal to N.

The first threshold may be understood as an interference threshold, and may be denoted as evm_dff_th. A value of the first threshold is not limited in this application. The difference between the absolute value of the first EVM and the absolute value of each of the N EVMs is greater than the first threshold. When the EVM is denoted as symbol_evm, the first EVM is denoted as best_evm, and the first threshold is denoted as evm_dff_th, the foregoing relationship is represented as |best_evm|−|symbol_evm|>evm_diff_th. Because a difference between the absolute value of the first EVM and the absolute value of the first EVM is always equal to 0, when an EVM other than the first EVM in the N EVMs is denoted as a second EVM, if a difference between the absolute value of the first EVM and an absolute value of the second EVM is greater than the first threshold, it indicates that an OFDM symbol corresponding to the second EVM is an interfered OFDM symbol. In this way, the quantity of differences greater than the first threshold is denoted as the first quantity, and a quantity of interfered OFDM symbols in the N OFDM symbols transmitted at the PHY may be counted, so that the ratio of the first quantity to N may be used as the proportion of the interfered OFDM symbols in the PPDU.

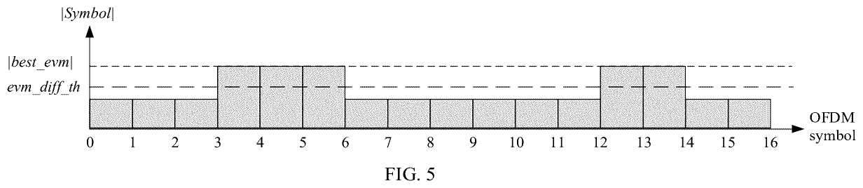

For example, FIG. 5 is a diagram of determining a proportion of interfered OFDM symbols in a PPDU according to an embodiment of this application. As shown in FIG. 5, a horizontal axis represents a quantity of OFDM symbols, each column represents one OFDM symbol, and there are 16 OFDM symbols in total, that is, N is 16. A vertical axis represents an absolute value of an EVM of an OFDM symbol, that is, |symbol_evm|. The absolute value of the first EVM is represented by |best_evm|, the first threshold is represented by evm_dsff_th, and the first quantity is 5. If the proportion of the interfered OFDM symbols in the PPDU is denoted as ppdu_interf_ratio, ppdu_interf_ratio=5/16×100%=31%.

2. When the Wi-Fi data frame is an AMPDU and the AMPDU includes M MPDUs, each of the M MPDUs is checked through a MAC layer of the receiver, to obtain a first MPDU with a check error, a second quantity of first MPDUs corresponding to an interfered OFDM symbol is determined through the MAC layer of the receiver, and the second quantity is used as a quantity of interfered MPDUs in the AMPDU through the MAC layer of the receiver.

M is a positive integer. Optionally, M is less than or equal to 256. A method for checking an MPDU is not limited in this application, and may be an FCS, a CRC, or the like. The first MPDU is an MPDU with a check error, and may be understood as an MPDU with a decoding error caused by interference. After the first MPDU is determined at the MAC layer of the receiver, whether the first MPDU includes an interfered OFDM symbol may be checked through a PHY of the receiver. If the first MPDU includes the interfered OFDM symbol, the first MPDU is determined as the first MPDU corresponding to the interfered OFDM symbol.

It may be understood that there is a correspondence between an OFDM symbol at the PHY and an MPDU at the MAC layer. After the first MPDU that fails the check at the MAC is determined, the second quantity of first MPDUs that correspond to the interfered OFDM symbol and that are at the MAC layer may be determined based on a correspondence between an interfered OFDM symbol determined at the PHY and an MPDU at the MAC layer. That is, the quantity of interfered MPDUs in the AMPDU is determined.

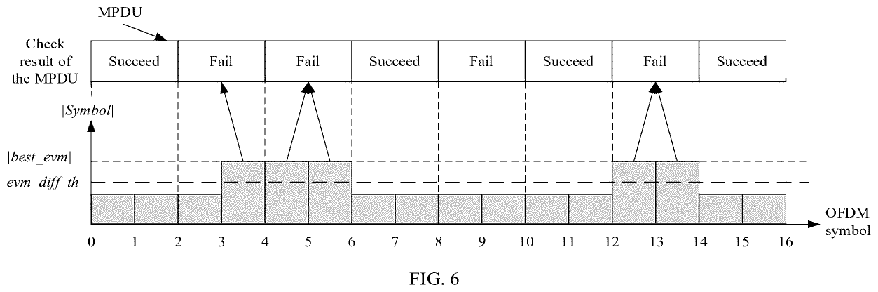

For example, FIG. 6 is a diagram of determining a quantity of interfered MPDUs in an AMPDU according to an embodiment of this application. As shown in FIG. 6, in the top three rows, a horizontal axis represents a quantity of OFDM symbols, each column represents one OFDM symbol, and there are 16 OFDM symbols in total, that is, N is 16. In the top three rows, a vertical axis represents an absolute value of an EVM of an OFDM symbol, that is, |symbol_evm|. The absolute value of the first EVM is represented by |best_evm|, the first threshold is represented by evm_dff_th, and the quantity of interfered OFDM symbols in the PPDU is 5. A bottom row represents check results of the MPDUs. It may be learned that there are four first MPDUs that fail the check, and it may be learned from a correspondence between these first MPDUs and OFDM symbols in the top three rows that there are three first MPDUs corresponding to interfered OFDM symbols. That is, the second quantity is 3. That is, when the quantity of interfered MPDUs in the AMPDU is denoted as interf_mpdu_num, interf_mpdu_num is 3.

After the interference information of the Wi-Fi data frame is determined, the interference information may be sent to the transmitter via the BA frame, or may be sent to the transmitter in another form (for example, through independent signaling or carried in other existing signaling). A form of the interference information in the BA frame is not limited in this application. Optionally, the interference information of the Wi-Fi data frame is located in a reserved field or a user-defined field of the block acknowledgment frame. In this way, the interference information of the Wi-Fi data frame may be transmitted by using the reserved field or the user-defined field.

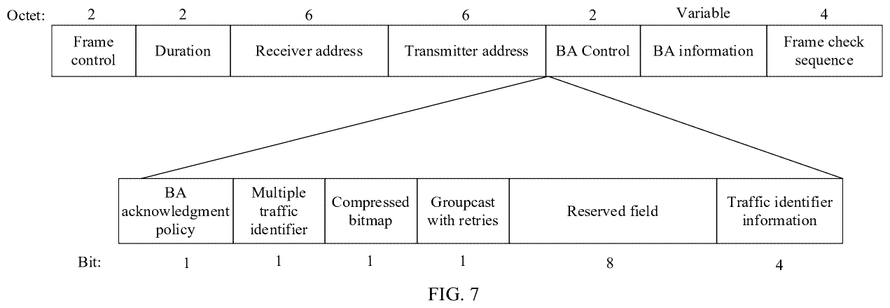

For example, FIG. 7 is a diagram of a structure of a BA frame. As shown in FIG. 7, a reserved field in a BA frame belongs a BA control field, the BA control field occupies two octets, and the reserved field occupies eight bits. The BA control field further includes a BA acknowledgment policy (BA Ack Policy) field, a multiple traffic identifier (Multi TID) field, a compressed bitmap field, and a groupcast with retries (GCR) field that separately occupy one bit, and a traffic identifier information (TID_INFO) field that occupies four bits. In addition to the BA control field, the BA frame further includes a frame control field and a duration field that separately occupy two octets, an FCS field that occupies four octets, a transmitter address (TA) field and a receiver address (RA) field that separately occupy six octets, and a BA information field whose field length is variable.

When the reserved field occupies eight bits, if the Wi-Fi data frame is a PPDU, a proportion, in the reserved field, of interfered OFDM symbols in the PPDU may be greater than or equal to 0 and less than or equal to 100%. If the Wi-Fi data frame is an AMPDU, a quantity, in the reserved field, of interfered MPDUs, in the AMPDU may be greater than or equal to 0 and less than or equal to 255.
S403: The transmitter determines a packet error rate of the Wi-Fi data frame based on a quantity of AMPDUs, a quantity of erroneous MPDUs, and the interference information of the Wi-Fi data frame.

The quantity of AMPUs may be denoted as aggr_mpdu_num, and the quantity of erroneous MPDUs may be denoted as error_mpdu_num. When the Wi-Fi data frame is a PPDU, data to be transmitted in the PPDU is encoded into N OFDM symbols, and a proportion of interfered OFDM symbols in the PPDU is denoted as ppdu_interf_ratio, 0, the packet error rate PER of the Wi-Fi data frame may be obtained through calculation according to Formula (1).

$$P E R = max \{ \frac{error\_mpdu \_num}{aggr\_mpdu \_num} \times 100 \% - ppdu\_interf \_ratio , 0 \} \qquad ( 1 )$$

When the Wi-Fi data frame is an AMPDU, the AMPDU includes M MPDUs, and a quantity of interfered MPDUs in the AMPDU is denoted as interf_mpdu_num, the packet error rate PER of the Wi-Fi data frame may be obtained through calculation according to Formula (2).

$$PER = \frac{error\_mpdu \_num - interf\_mpdu \_num}{aggr\_mpdu \_num} \times 100 \% \qquad ( 2 )$$

In the communication method shown in FIG. 4, after receiving the Wi-Fi data frame from the transmitter, the receiver sends the BA frame to the transmitter. The BA frame includes the interference information of the Wi-Fi data frame. In other words, when the receiver is interfered and transmission of some subframes fails due to a collision, the interference information is fed back to the transmitter. Then, the transmitter may determine the packet error rate of the Wi-Fi data frame based on the interference information of the Wi-Fi data frame, the quantity of erroneous MPDUs, and the quantity of AMPDUs. In this way, the transmitter takes impact of an interference signal into consideration, thereby improving accuracy of collecting statistics on a packet error rate by the transmitter.

The methods in embodiments of this application are described in detail above, and apparatuses in embodiments of this application are provided below.

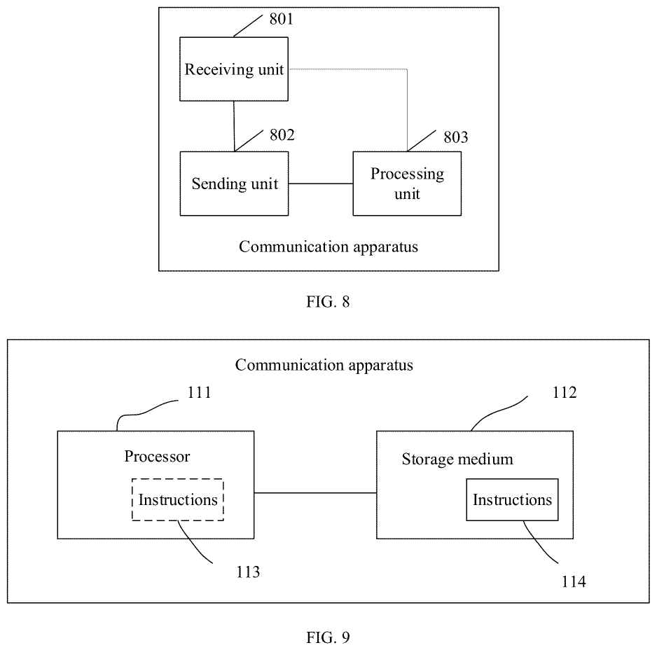

FIG. 8 is a diagram of a structure of a communication apparatus according to an embodiment of this application. The communication apparatus may include a receiving unit 801, a sending unit 802, and a processing unit 803. The receiving unit 801 may be an apparatus having a signal input (or receiving) function, and the sending unit 802 may be an apparatus having a signal output (or sending) function. The receiving unit 801 and the sending unit 802 are configured to perform signal transmission with another device or another component in the device. The processing unit 803 may be an apparatus having a processing function, and may include one or more processors configured to execute instructions (or code or a program), for example, process a communication protocol and communication data.

The communication apparatus may be a receiver. In this embodiment of this application, a function performed by the receiver may be performed by an apparatus in the receiver. Alternatively, the communication apparatus may be a transmitter. In this embodiment of this application, a function performed by the transmitter may be performed by an apparatus in the transmitter. The following uses a transmitter or a receiver as an example for description.

When the communication apparatus is a receiver, the receiving unit 801 is configured to receive a Wi-Fi data frame from a transmitter.

The sending unit 802 is configured to send a block acknowledgment frame to the transmitter, where the block acknowledgment frame includes interference information of the Wi-Fi data frame.

In an example, the Wi-Fi data frame includes a PPDU, data to be transmitted in the PPDU is encoded into N OFDM symbols, the interference information of the Wi-Fi data frame is a proportion of interfered OFDM symbols in the PPDU, and N is a positive integer. The processing unit 803 is configured to record an EVM of each of the N OFDM symbols through a PHY, to obtain N EVMs, where the N EVMs include a first EVM, and an absolute value of the first EVM is a maximum value of absolute values of the N EVMs, determine a difference between the absolute value of the first EVM and the absolute value of each of the N EVMs through the PHY, determine a first quantity of differences greater than a first threshold through the PHY, and use a ratio of the first quantity to N as the proportion of the interfered OFDM symbols in the PPDU through the PHY.

In an example, the Wi-Fi data frame includes an AMPDU, the AMPDU includes M MPDUs, the interference information of the Wi-Fi data frame is a quantity of interfered MPDUs in the AMPDU, and M is a positive integer. The processing unit 803 is configured to check each of the M MPDUs through a MAC layer, to obtain a first MPDU with a check error, determine, through the MAC layer, a second quantity of first MPDUs corresponding to an interfered OFDM symbol, where a difference between an absolute value of an EVM of the interfered OFDM symbol and an absolute value of a first EVM is less than a first threshold, the first EVM is a maximum value of absolute values of N EVMs, and the N EVMs include an EVM of each of N OFDM symbols obtained from PPDU encoding, and use the second quantity as the quantity of interfered MPDUs in the AMPDU through the MAC layer.

In an example, M is less than or equal to 256.

In an example, the interference information of the Wi-Fi data frame is located in a reserved field or a user-defined field of the block acknowledgment frame.

When the communication apparatus is a transmitter, the sending unit 802 is configured to send a Wi-Fi data frame to a receiver.

The receiving unit 801 is configured to receive a block acknowledgment frame from the receiver, where the block acknowledgment frame includes interference information of the Wi-Fi data frame.

The processing unit 803 is configured to determine a packet error rate of the Wi-Fi data frame based on a quantity of AMPDUs, a quantity of erroneous MPDUs, and the interference information of the Wi-Fi data frame.

In an example, the Wi-Fi data frame includes a PPDU, data to be transmitted in the PPDU is encoded into N OFDM symbols, the interference information of the Wi-Fi data frame is a proportion of interfered OFDM symbols in the PPDU, N is a positive integer, and the packet error rate (PER) of the Wi-Fi data frame is obtained through calculation according to the following formula:

$$PER = max \{ \frac{error\_mpdu \_num}{aggr\_mpdu \_num} \times 100 \% - ppdu\_interf \_ratio , 0 \}$$

where error_mpdu_num is the quantity of erroneous MPDUs, aggr_mpdu_num is the quantity of AMPDUs, and ppdu_interf_ratio is the proportion of the interfered OFDM symbols in the PPDU.

In an example, the Wi-Fi data frame includes an AMPDU, the AMPDU includes M MPDUs, the interference information of the Wi-Fi data frame is a quantity of interfered MPDUs in the AMPDU, M is a positive integer, and the packet error rate PER of the Wi-Fi data frame is obtained through calculation according to the following formula:

$$PER = \frac{error\_mpdu \_num - interf\_mpdu \_num}{aggr\_mpdu \_num} \times 100 \%$$

where error_mpdu_num is the quantity of erroneous MPDUs, aggr_mpdu_num is the quantity of AMPDUs, and interf_mpdu_num is the quantity of interfered MPDUs in the AMPDU.

For implementation of the receiving unit 801, the sending unit 802, and the processing unit 803, refer to related descriptions in FIG. 4. Details are not described herein again.

FIG. 9 is a diagram of a structure of another communication apparatus according to an embodiment of this application. The communication apparatus may be a transmitter or a receiver, and is configured to implement the method described in the method embodiments. As shown in FIG. 9, the communication apparatus may include a processor 111 and a storage medium 112. The processor 111 may also be referred to as a processing unit, and may implement a specific control function. The storage medium 112 may also be referred to as a storage unit or a memory. The storage medium 112 stores instructions 114. The instructions 114 may be run on the processor 111, so that the communication apparatus performs the method described in FIG. 4 in embodiments of this application.

Optionally, the processor 111 may include instructions 113, and the instructions 113 may be run on the processor 111, so that the communication apparatus performs the method described in FIG. 4 in embodiments of this application.

The communication apparatus described in the foregoing embodiment may be a terminal, but a scope of the apparatus described in this application is not limited thereto. The communication apparatus may be an independent device or may be a part of a large device. For example, the communication apparatus may be: (1) an independent integrated circuit (IC), a chip, or a chip system or subsystem; (2) a set including one or more ICs, where optionally, the IC set may include a storage component configured to store data and/or instructions; (3) an application-specific IC (ASIC), for example, a modem; or (4) a module that can be embedded in another device.

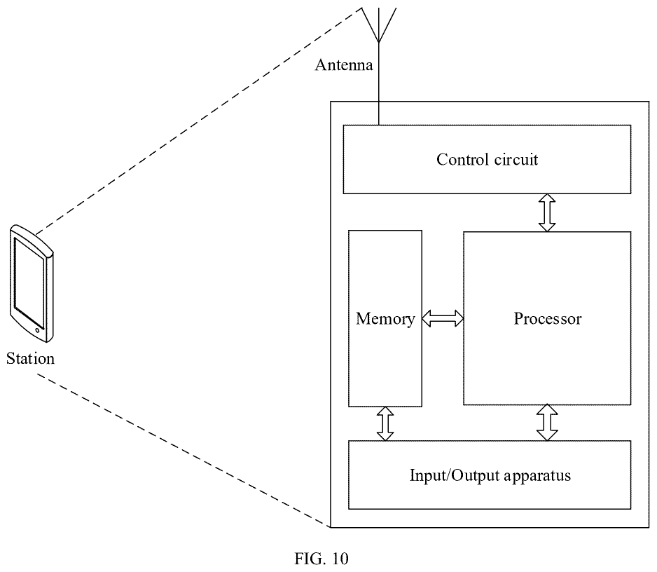

FIG. 10 is a diagram of a structure of an STA according to an embodiment of this application. For ease of description, FIG. 10 shows only main components of the STA. As shown in FIG. 10, the STA includes a processor, a memory, a control circuit, an antenna, and an input/output apparatus. The processor is mainly configured to process a communication protocol and communication data, control the entire STA, execute a software program, and process data of the software program. The memory is mainly configured to store the software program and data. A radio frequency circuit is mainly configured to perform conversion between a baseband signal and a radio frequency signal, and process the radio frequency signal. The antenna is mainly configured to receive and send a radio frequency signal in a form of an electromagnetic wave. The input/output apparatus, for example, a touchscreen, a display, or a keyboard, is mainly configured to receive data input by a user and output data to the user.

After the STA is powered on, the processor may read a software program in a storage unit, interpret and execute instructions of the software program, and process data of the software program. When data needs to be sent in a wireless manner, the processor performs baseband processing on to-be-sent data, and then outputs a baseband signal to the radio frequency circuit. The radio frequency circuit processes the baseband signal to obtain a radio frequency signal, and sends the radio frequency signal to the outside in a form of an electromagnetic wave through the antenna. When data is sent to the STA, the radio frequency circuit receives a radio frequency signal through the antenna, further converts the radio frequency signal into a baseband signal, and outputs the baseband signal to the processor. The processor converts the baseband signal into data, and processes the data.

For ease of description, only one memory and one processor are shown in FIG. 10. In an actual STA, there may be a plurality of processors and a plurality of memories. The memory may also be referred to as a storage medium, a storage device, or the like. This is not limited in embodiments of this application.

In an embodiment, the antenna is configured to perform operations performed by the receiving unit 801 and the sending unit 802 in the foregoing embodiment. The processor is configured to perform operations performed by the processing unit 803 in the foregoing embodiment. The STA may be further configured to perform the method performed by the STA in FIG. 4. Details are not described herein again.

An embodiment of this application further provides a computer-readable storage medium, and the computer-readable storage medium stores a computer program. When the program is executed by a processor, a procedure related to the transmitter or the receiver in the communication method provided in the foregoing method embodiments may be implemented.

An embodiment of this application further provides a computer program product. The computer program product is configured to store a computer program. When the computer program runs on a computer (or a processor), the computer is enabled to perform one or more steps in any one of the foregoing communication methods. When each component module of the foregoing device is implemented in a form of a software functional unit and sold or used as an independent product, the component module may be stored in a computer-readable storage medium.

An embodiment of this application provides a chip, including a processor configured to invoke, from a memory, instructions stored in the memory and run the instructions, to enable a communication apparatus on which the chip is installed to perform any one of the foregoing methods.

An embodiment of this application further provides another chip, including an input interface, an output interface, and a processing circuit. The input interface, the output interface, and the circuit are connected through an internal connection path. The processing circuit is configured to perform any one of the foregoing methods. Optionally, the chip further includes a memory. The input interface, the output interface, a processor, and the memory are connected through an internal connection path. The processor is configured to execute code in the memory. When the code is executed, the processor is configured to perform any one of the foregoing methods.

An embodiment of this application further provides a chip system, including at least one processor and a communication interface. The communication interface and the at least one processor are interconnected through a line. The at least one processor is configured to run a computer program or instructions, to perform any one of the foregoing methods. The chip system may include a chip, or may include a chip and another discrete device.

An embodiment of this application further provides a communication system. The system includes a transmitter and a receiver. For specific descriptions, refer to the method shown in FIG. 4.

It should be understood that the memory mentioned in embodiments of this application may be a volatile memory or a non-volatile memory, or may include both a volatile memory and a non-volatile memory. The non-volatile memory may be a hard disk drive (HDD), a solid-state drive (SSD), a read-only memory (ROM), a programmable ROM (PROM), an erasable PROM (EPROM), an electrically EPROM (EEPROM), or a flash memory. The volatile memory may be a random-access memory (RAM), and serves as an external cache. The memory is any other medium that can carry or store expected program code in a form of instructions or a data structure and that can be accessed by a computer, but is not limited thereto. The memory in embodiments of this application may alternatively be a circuit or any other apparatus that can implement a storage function, and is configured to store program instructions and/or data.

It should be further understood that the processor mentioned in embodiments of this application may be a central processing unit (CPU), or may be another general-purpose processor, a digital signal processor (DSP), an ASIC, a field-programmable gate array (FPGA) or another programmable logic device, a discrete gate or a transistor logic device, a discrete hardware component, or the like. The general-purpose processor may be a microprocessor, or the processor may be any processor or the like.

It should be noted that when the processor is a general-purpose processor, a DSP, an ASIC, an FPGA or another programmable logic device, a discrete gate, a transistor logic device, or a discrete hardware component, the memory (a storage module) is integrated into the processor.

It should be noted that the memory described in this specification aims to include but is not limited to these memories and any memory of another appropriate type.

A person of ordinary skill in the art may be aware that units and algorithm steps in the examples described with reference to embodiments provided in this specification may be implemented by electronic hardware or a combination of computer software and electronic hardware. Whether the functions are performed by hardware or software depends on particular applications and design constraints of the technical solutions. A person skilled in the art may use different methods to implement the described function for each particular application, but it should not be considered that the implementation goes beyond the scope of this application.

In the several embodiments provided in this application, it should be understood that the disclosed system, apparatus, and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

A sequence of the steps of the method in embodiments of this application may be adjusted, combined, or removed based on an actual requirement. Steps in each embodiment may be partially performed (for example, the terminal may not perform the steps performed by the terminal in the foregoing embodiments). An execution sequence of different steps may be changed. Embodiments described in this specification may be combined with other embodiments, different embodiments may be combined with each other, and different steps of different embodiments in this specification may be combined.

The modules/units in the apparatuses in embodiments of this application may be combined, divided, or removed based on an actual requirement.

“Embodiments” mentioned in this specification mean that specific features, structures, or characteristics described in combination with embodiments may be included in at least one embodiment of this application. The phrase shown in various locations in this specification may not necessarily refer to a same embodiment, and is not an independent or optional embodiment exclusive from another embodiment.

“Protocols” in this application may be communication protocols or specifications, for example, a 3GPP communication protocol.

Terms “first”, “second”, “third”, “fourth”, and the like (if any) in embodiments of this application are used to distinguish between similar objects but do not necessarily indicate a specific order or sequence.

In embodiments of this application, “include” may indicate an inclusion relationship, or an equal relationship. For example, if A includes B, A may include other content in addition to B, or A and B are same content.

In the descriptions of this application, unless otherwise specified, “/” indicates an “or” relationship between associated objects. For example, A/B may indicate A or B. In this application, “and/or” merely describes an association relationship between associated objects and indicates that three relationships may exist. For example, A and/or B may indicate the following three cases: only A exists, both A and B exist, and only B exists, where A and B may be singular or plural. In addition, in the descriptions of this application, unless otherwise specified, “a plurality of” means two or more than two. “At least one of the following items (pieces)” or a similar expression thereof means any combination of these items, including a singular item (piece) or any combination of plural items (pieces). For example, at least one item (piece) of a, b, or c may indicate: a, b, c, a and b, a and c, b and c, or a, b, and c, where a, b, and c may be singular or plural.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

1. A communication method comprising:
receiving a Wi-Fi data frame;
obtaining interference information of the Wi-Fi data frame; and
sending a block acknowledgment frame,
wherein the block acknowledgment frame comprises the interference information, and
wherein the interference information is located in a reserved field of the block acknowledgment frame or a user-defined field of the block acknowledgement frame.

2. The communication method of claim 1, wherein the Wi-Fi data frame comprises a physical protocol data unit (PPDU), wherein the PPDU comprises data that is encoded into N orthogonal frequency-division multiplexing (OFDM) symbols, wherein the interference information comprises a proportion of interfered OFDM symbols in the PPDU, wherein N is a positive integer, and wherein the communication method further comprises:
recording an error vector magnitude (EVM) of each of the N OFDM symbols through a physical layer (PHY) to obtain N EVMs, wherein the N EVMs comprise a first EVM, and wherein a first absolute value of the first EVM is a maximum value of N absolute values of the N EVMs;
determining differences between the first absolute value and the N absolute values through the PHY;
determining a first quantity of the differences that is greater than a threshold through the PHY; and
using a ratio of the first quantity to N as the proportion.

3. The communication method of claim 1, wherein the Wi-Fi data frame comprises an aggregated medium access control protocol data unit (AMPDU), wherein the AMPDU comprises M medium access control protocol data units (MPDUs), wherein the interference information comprises a first quantity of interfered MPDUs in the AMPDU, wherein M is a positive integer, and wherein the communication method further comprises:
checking each of the M MPDUs through a medium access control (MAC) layer to obtain first MPDUs comprising check errors;
determining, through the MAC layer, a second quantity of first MPDUs corresponding to an interfered orthogonal frequency-division multiplexing (OFDM) symbol, wherein a difference between a first absolute value of a first error vector magnitude (EVM) of the interfered OFDM symbol and a second absolute value of a second EVM is less than a threshold, wherein the second EVM is a maximum value of absolute values of N EVMs, and wherein the N EVMs comprise an EVM of each of N OFDM symbols of physical protocol data unit (PPDU) encoding; and
using the second quantity as the first quantity of interfered MPDUs through the MAC layer.

4. The communication method of claim 3, wherein M is less than or equal to 256.

5. The communication method of claim 3, further comprising receiving, using a unified Physical Layer Convergence Protocol (PLCP) preamble, the M MPDUs.

6. The communication method of claim 5, further comprising receiving a notification comprising the PLCP preamble from a peer.

7. The communication method of claim 1, wherein the Wi-Fi data frame comprises an aggregated medium access control protocol data unit (AMPDU), and wherein the AMPDU comprises a plurality of medium access control (MAC) service data units (MSDUs) and a MAC header.

8. A communication method comprising:
sending a Wi-Fi data frame;
receiving a block acknowledgment frame, wherein the block acknowledgment frame comprises interference information of the Wi-Fi data frame; and
determining a packet error rate of the Wi-Fi data frame based on a first quantity of aggregated medium access control protocol data units (AMPDUs), a second quantity of erroneous MPDUs, and the interference information.

9. The communication method of claim 8, wherein the Wi-Fi data frame comprises a physical protocol data unit (PPDU), wherein the PPDU comprises data that is encoded into N orthogonal frequency-division multiplexing (OFDM) symbols, wherein the interference information comprises a proportion of interfered OFDM symbols in the PPDU, wherein N is a positive integer, wherein the communication method further comprises obtaining the packet error rate (PER) of the Wi-Fi data frame through calculation according to a formula, wherein the formula comprises:
$$P E R = max \{ \frac{{error}_{mpd {u}_{n u m}}}{agg {r}_{m p d {u}_{n u m}}} \times 100 \% - p p d {u}_{{interf}_{r a t i o}} , 0 \} ,$$
wherein error_mpdu_num is the second quantity, wherein aggr_mpdu_num is the first quantity, and wherein ppdu_interf_ratio is the proportion.

10. The communication method of claim 8, wherein the Wi-Fi data frame comprises an AMPDU, wherein the AMPDU comprises M medium access control protocol data units (MPDUs), wherein the interference information comprises a third quantity of interfered MPDUs in the AMPDU, wherein M is a positive integer, wherein the communication method further comprises obtaining the packet error rate (PER) of the Wi-Fi data frame through calculation according to a formula, wherein the formula comprises:
$$P E R = \frac{{error}_{m p d {u}_{n u m}} - {interf}_{m p d {u}_{n u m}}}{a g g {r}_{m p d {u}_{n u m}}} \times 100 \% ,$$
wherein error_mpdu_num is the second quantity, wherein aggr_mpdu_num is the first quantity, and wherein interf_mpdu_num is the third quantity.

11. The communication method of claim 10, wherein M is less than or equal to 256.

12. The communication method of claim 10, further comprising transmitting, using a unified Physical Layer Convergence Protocol (PLCP) preamble, the M MPDUs.

13. The communication method of claim 12, further comprising transmitting a notification comprising the PLCP preamble to a peer.

14. The communication method of claim 8, The communication method of claim 1, wherein the Wi-Fi data frame comprises an aggregated medium access control protocol data unit (AMPDU), and wherein the AMPDU comprises a plurality of medium access control (MAC) service data units (MSDUs) and a MAC header.

15. A communication apparatus comprising:
a memory configured to store instructions; and
one or more processors coupled to the memory, wherein when executed by the one or more processors, the instructions cause the communication apparatus to:
receive a Wi-Fi data frame;
obtain interference information of the Wi-Fi data frame; and
send a block acknowledgment frame,
wherein the block acknowledgment frame comprises the interference information, and
wherein the interference information is located in a reserved field of the block acknowledgment frame or a user-defined field of the block acknowledgement frame.

16. The communication apparatus of claim 15, wherein the Wi-Fi data frame comprises a physical protocol data unit (PPDU), wherein the PPDU comprises data that is encoded into N orthogonal frequency-division multiplexing (OFDM) symbols, wherein the interference information comprises a proportion of interfered OFDM symbols in the PPDU, wherein N is a positive integer, and wherein when executed by the one or more processors, the instructions further cause the communication apparatus to:
record an error vector magnitude (EVM) of each of the N OFDM symbols through a physical layer (PHY) to obtain N EVMs, wherein the N EVMs comprise a first EVM, and wherein a first absolute value of the first EVM is a maximum value of N absolute values of the N EVMs;
determine differences between the first absolute value and the N absolute values through the PHY;
determine a first quantity of the differences that is greater than a threshold through the PHY layer; and
use a ratio of the first quantity to N as the proportion of the interfered OFDM symbols through the PHY layer.

17. The communication apparatus of claim 15, wherein the Wi-Fi data frame comprises an aggregated medium access control protocol data unit (AMPDU), wherein the AMPDU comprises M medium access control protocol data units (MPDUs), wherein the interference information comprises a first quantity of interfered MPDUs in the AMPDU, wherein M is a positive integer, and wherein when executed by the one or more processors, the instructions further cause the communication apparatus to:
check each of the M MPDUs through a MAC layer to obtain first MPDUs comprising check errors;
determine, through the MAC layer, a second quantity of first MPDUs corresponding to an interfered orthogonal frequency-division multiplexing (OFDM) symbol, wherein a difference between a first absolute value of a first error vector magnitude (EVM) of the interfered OFDM symbol and a second absolute value of a second EVM is less than a threshold, wherein the second EVM is a maximum value of absolute values of N EVMs, and wherein the N EVMs comprise an EVM of each of N OFDM symbols of physical protocol data unit (PPDU) encoding; and
use the second quantity as the first quantity of interfered MPDUs through the MAC layer.

18. The communication apparatus of claim 17, wherein M is less than or equal to 256.

19. The communication apparatus of claim 17, wherein when executed by the one or more processors, the instructions further cause the communication apparatus to receive, using a unified Physical Layer Convergence Protocol (PLCP) preamble, the M MPDUs.

20. The communication apparatus of claim 15, wherein the Wi-Fi data frame comprises an aggregated medium access control protocol data unit (AMPDU), and wherein the AMPDU comprises a plurality of medium access control (MAC) service data units (MSDUs) and a MAC header.
